(19) United States
(12) Patent Application Publication
(10) Pub. No.: US 2003/0136631 A1
(43) Pub. Date: Jul. 24, 2003

(54) Coin detection apparatus

(76) Inventors: Kouji Nakashima, Taito-Ku (JP); Yasuyuki Nakanishi, Taito-Ku (JP)

Correspondence Address: JACOBSON HOLMAN PLLC, 400 SEVENTH STREET N.W., SUITE 600, WASHINGTON, DC, 20004, US

(21) Appl. No.: 10/375,126

(22) Filed: Feb. 28, 2003

Related U.S. Application Data
(63) Continuation of application No. PCT/JP02/01959, filed on Mar. 4, 2002.

(30) Foreign Application Priority Data
Mar. 4, 2001 (JP) 2001-110643

(51) Int. Cl. G07D 5/02

(52) U.S. Cl. 194/335

(57) ABSTRACT

The present invention is directed to a coin detection apparatus that is specially designed to avoid coins' sticking in a coin passage and that is capable of distributing an item to a customer only when a predetermined number of valid coins are paid. Coins (C) deposited by the customer are kept in a coin shoot (13). The coins (C) stand upright on a floor plate (20) that forms a part of the coin shoot (13). The floor plate (20) is urged by a spring member to protrude into the coin shoot (13). As a rotary disk (100) rotates, one end (119) of a recessed portion (120) defined in the rotary disk (100) leans on the floor plate (20) against elastic force of the spring member to make the floor plate (20) tilt. Subsequently, recessed edge of the rotary disk (100) continues to tilt the floor plate (20). As the other end 118 of the recessed portion (120) reaches the floor plate (20), the floor plate (20) is disengaged from the rotary disk (100). Tilt of the floor plate (20) causes the coins (C) to be evacuated from the floor plate (20), and the coins fall direction into a coin drop.

### FIELD OF THE INVENTION

The present invention relates to a vending machine that stores lots of packaged commercial items such as toys and distributes them, and more particularly, it relates to a manual vending machine of which rotational handle is turned by a customer to distribute and vend an item contained in the machine. Also, the present invention is directed to a coin detection apparatus that is installed in such a manual vending machine, and it enables the rotational handle to turn if prescribed numbers of specified coins are deposited but, if not, it does not permit the rotational handle to turn.

### BACKGROUND ART

These days, customers who want to purchase toys have often got toys packaged in containers such as capsules from manual vending machines. Such manual vending machines usually distribute products on the one-machine-one-item or one-machine-two-item basis for predetermined prices, and recently a wider variety of toys have possibly been purchased from the vending machines. Thus, more than one of the manual vending machines are typically installed side by side right in front of shops.

The prior art manual vending machine of this type must be designed to permit a customer to turn a rotational handle of the machine only if valid numbers (hereinafter referred to as “prescribed number(s)”) of specific coins for the price of a toy are deposited, so as to take the item out. For this purpose, the prior art vending machine usually has a coin detection apparatus built in.

Such a prior art coin detection apparatus is disclosed in Japanese Patent Laid-open No. H10-143722. The coin detection apparatus described in the Official Gazette for the invention will be discussed in conjunction with FIGS. 16 and 17 which are diagrams illustrating features of the prior art coin detection apparatus. In these figures, like components are denoted by identical reference numerals. Detailed below will be a case where the rotational handle can be turned to get an item only when two of coins are deposited.

In an upper portion of the coin detection apparatus, there is provided coin shoot 1603 conducting from a coin shoot inlet 1601 to a coin shoot outlet 1602. The coin shoot inlet 1601 is defined to be opposed to a coin drop slot when a coin detection apparatus 1600 is mounted in the manual vending machine not shown. Below the coin shoot 1603, a coin sorting unit 1604 is provided to distribute coins passed through the shoot outlet 1602. The coin sorting unit 1604 discriminatively gathers valid ones for a predetermined value among the coins from the outlet 1602 and sends them to a coin duct inlet 1605 while dropping the remaining invalid coins into a return drop 1606.

From the coin duct inlet 1605, a coin duct 1608 leads down to the coin duct outlet 1607 which, in turn, leads to a bank box (not shown) of the vending machine. Part of the coin duct 1608 is slanted relative to a horizontal plane so that the coins from the coin duct inlet 1605 can keep upright and move down by virtue of their own weight where each coin has its opposite sides almost orthogonal to the horizontal plane. In addition to that, the coin duct 1608 thoroughly extends with a fixed width slightly larger than a thickness of each coin, thereby allowing the coins passed through the outlet 1605 to roll.

The coin duct 1608 has an opening 1609 which is opened and closed by pivotal movement of a fan-shaped lid 1611 about a fulcrum shaft 1610. The lid 1611 is urged by spring (not shown) in the same direction to keep the opening shielded. The pivotal movement of the lid 1611 is caused by a customer who presses an element (not shown) of the vending machine associated with the lid 1611 and serving as a trigger to return coins. The opening 1609 leads to a coin return 1613 which extends down to an exit 1612.

From the return drop 1606, a duct 1614 extends down to the coin return 1613.

Close to the coin duct 1608, a rotary disk 1616 is placed, and it is capable of rotating about a rotation shaft 1615. The rotary disk is associated with a rotational handle (not shown) of the vending machine, and is operable correlative to turns of the rotational handle.

The rotary disk 1616 includes a circular guide 1617 which is eccentric to the disk itself, having a center deviated from the rotation shaft 1615. Positioned on an outer circumference of the rotary disk 1616 is an end-piece 1621 that can abut against a stopper 1620 and is urged by spring 1619, which has its one end fixed to an anchored stake 1618. A step 1624 shaped in the stopper 1620 can abut against an end-piece 1625 which is an element of a detecting member 1626 movable both upward and downward. The detecting member 1626 moves up when its lower edge 1627 comes in contact with a circumferential edge of a coin C, so as not to protrude into the coin duct 1608 while it moves down and protrudes in the coin duct 1608 when the edge 1627 is not in contact with the coin C.

A pin 1623 of a shutter 1622 capable of moving up and down is fitted in the guide 1617 of the rotary disk 1616. With the pin 1623 fitting in the guide 1617 in this manner, the shutter 1622 responds to rotational movement of the rotary disk 1616 to block and open the coin duct 1608.

Functions of the coin detection apparatus thus configured will be described. In an initial stage of actuation, as can be seen in FIG. 16, the shutter 1622 blocks the coin duct 1608 while the tip 1627 of the detecting element 1626 protrudes into the coin duct 1608, and synchronously the opening 1609 is closed by the lid 1611. Coins deposited by the customer, after passing through the coin shoot 1603, are dropped through the coin shoot outlet 1602 into the coin sorting unit 1604.

Coins passed through the outlet 1602 and sorted as being invalid, if any, are sent to the return drop 1606. Such coins, after falling through the duct 1614 and entering the return 1613, roll due to their own weight down to the exit 1612 where the customer get them.

Coins from the outlet 1602, if distributed into valid ones, are sent to the coin duct inlet 1605 by the coin sorting unit 1604. Such coins roll in the duct 1608 till they reach a midway where the shutter 1622 blocks the duct, and then stop rolling. Once the detecting member 1626 protruding into the duct 1608 comes in contact with any of the coins, it is moved up and detracted from the duct, and the detecting member moves down into the duct 1608 again unless it is in contact with the coin. In this way, if only one coin is sorted as being valid, the stopper 1620 cannot horizontally move as denoted by an arrow since the end-piece 1625 of the detecting member 1626 abuts against the step 1624 of the stopper 1620. In this situation, abutment of the end-piece 1621 on the stopper 1620 inhibits the rotational disk 1616 from rotating, and this obliges the customer to abandon an attempt to turn the rotational handle. Thus, the rotational handle is not turned by the customer.

Once the coins are held in the duct 1608 temporarily blocked by the stopper 1622, the lid 1611 reacts to customer's depressing the element not shown by pivoting and allowing the coins to clear the opening 1609 into the coin return 1613. Then, the coins temporarily kept roll because of their own weights down to the exit 1612 so as to be returned to the customer.

In an example of FIG. 17, two of the coins sorted as valid are held in the duct 1608. In a situation as can be recognized in FIG. 17, the detecting member 1626 comes in contact with the second one of the coins and then moves up. Thus, the stopper 1620 is permitted to horizontally move as denoted by the arrow since it has the step 1624 released from the abutment by the end-piece 1625 of the detecting member 1626. In this stage of the actuation, an attempt of the customer to turn the rotational handle can be permitted by rotary disk 1616 that is enabled to rotate while the end-piece 1621 still abuts against the stopper 1620. Thus, the rotational handle can be turned by the customer.

As the rotary disk 1616 is rotated, the stopper 1622 coupled to the guide 1617 of the rotary disk 1616 moves up to unblock the coin duct 1608. Then, the coins temporarily held roll by their own weights and drop through the coin duct outlet 1607 into a bank box not shown.

As has been described, depositing a prescribed number of valid coins and turning the rotational handle, the customer can purchase and get an item because of mechanism not shown but linked and cooperative with the rotational handle.

The prior art manual vending machine having the above-mentioned coin detection apparatus built in has some disadvantages as discussed below. First, it is intended in the prior art coin detection apparatus that, when the customer depresses the element to have the deposited coins return, the lid 1611 moves itself to unblock the opening 1609, and then, the coins roll due to their own weights through the coin return 1613 down to the exit 1612. However, an insufficient inclination of the return 1613 might have the coins stick in the midst of the return. In this case, the customer encounter a trouble that he or she does not get changes reimbursed. Especially, when coins for some values stick in the return 1613, the trouble the customer meets is worse than he or she cannot connive at it.

Second, it is also intended in the prior art coin detection apparatus that as the customer turns the rotational handle to get an item, the rotary disk 1616 is correlatively rotated as mentioned above, and then, the stopper 1622 unblocks the coin duct 1608 so that the coins temporarily held in the duct 1608 roll by their own weights and drop through the coin duct outlet 1607. However, an insufficient inclination of the coin duct 1608 also causes the coins to stick in the duct 1608 and linger therein.

Especially, when more than one coins are deposited in the duct 1608, one is pushed by the chasing coin while both of them is rolling by their own weights in the duct 1608. In this case, two of the coins might be partially side by side and jam in the duct 1608 that is designed to have a width slightly larger than a thickness of the single valid coin. Besides the width of the duct, some other factors might cause more than one coins to interfere with each other and jam the duct 1608 anywhere therethrough.

Thirdly, in the prior art coin detection apparatus, only when the detecting member 1626 is in contact with the coin, the rotary disk 1616 is permitted to rotate. This means that diameters of the deposited coins must be valid to enable the rotary disk 1616 to rotate. However, counterfeit coins valid in diameter but different in thickness from genuine coins also probably permit the rotary disk 1616 if the prescribed number of them are deposited. Thus, there is a need for the coin detection apparatus that enables the rotary disk to rotate only if both the diameter and thickness of the deposited coins are authenticated.

Fourthly, in order to install the prior art coin detection apparatus in the manual vending machine, means such as screws are usually used to fix it. This results in installation and removal of the coin detection apparatus to and from the vending machine becoming annoying. Moreover, only skilled personnel can appropriately register the coin detection apparatus relative to the vending machine so that the coin shoot inlet 1601 of the former is opposed to the coin drop in the latter while the exit of the coin return in the former is opposed to a coin tray of the latter.

Fifthly, as has been stated, it is usual that more than one of the manual vending machines, each having the prior art detection apparatus built in, are set in the same location. Since they stand laterally in line, for example, each of the vending machines is settled unstably by itself and relative to the other.

Accordingly, it is an object of the present invention to provide a coin detection apparatus that can prevent coin jam and vend a commercial item to a customer only when a prescribed number of valid coins are deposited.

It is another object of the present invention to provide a coin detection apparatus of which installation in a manual vending machine is facilitated.

### BRIEF DESCRIPTION OF THE DRAWINGS

FIG. 1 is an anterior perspective view showing a manual vending machine that has an embodiment of a coin detection apparatus according to the present invention built in;

FIG. 2 is a posterior perspective view showing the manual vending machine that has the coin detection apparatus built in;

FIG. 3 is a vertical sectional view illustrating an inside configuration of the manual vending machine that has the coin detection apparatus built in;

FIG. 4 is a left side perspective view depicting an embodiment of the coin detection apparatus according to the present invention;

FIG. 5 is a perspective view illustrating the coin detection apparatus in FIG. 4 installed in the manual vending machine;

FIG. 6 is a perspective view of the coin detection apparatus in FIG. 6, showing its major portion enlarged;

FIG. 7 is a right side perspective view of the coin detection apparatus in FIG. 4;

FIGS. 8 to 10 are perspective views of the coin detection apparatus in FIG. 7, showing its major portion enlarged;

FIGS. 11A and 11B are sectional views respectively showing a structural example of a guide member 31 in an embodiment of the coin detection apparatus according to the present invention;

FIGS. 12 to 15 are perspective views of the coin detection apparatus in FIG. 4, showing its major portion enlarged; and

FIGS. 16 and 17 are diagrams of an actuation scheme of a prior art coin detection apparatus, respectively illustrating a vertical cross section perpendicular to a rotation axis of a rotary disk.

Throughout the accompanying drawings, like components are denoted by identical reference numerals.

### BEST MODE OF THE INVENTION

General Structure of Manual Vending Machine

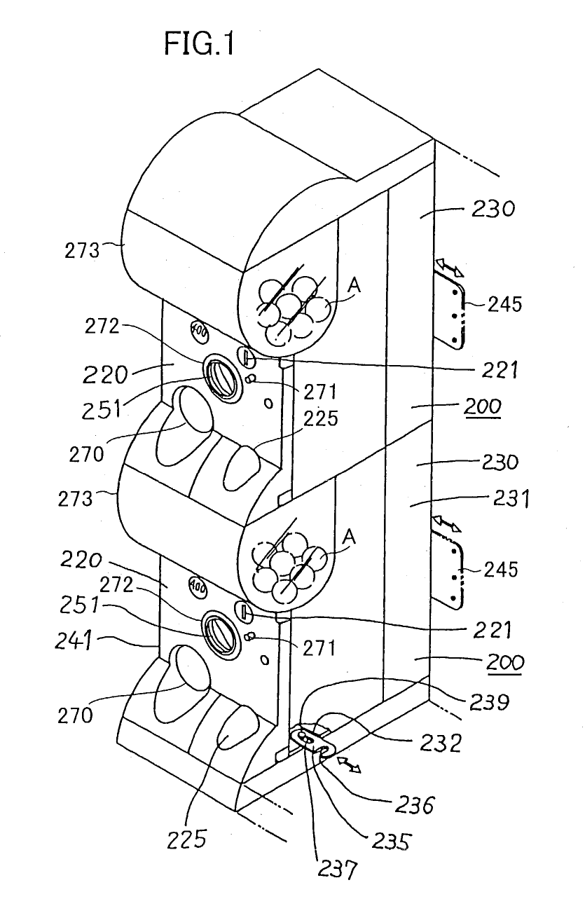

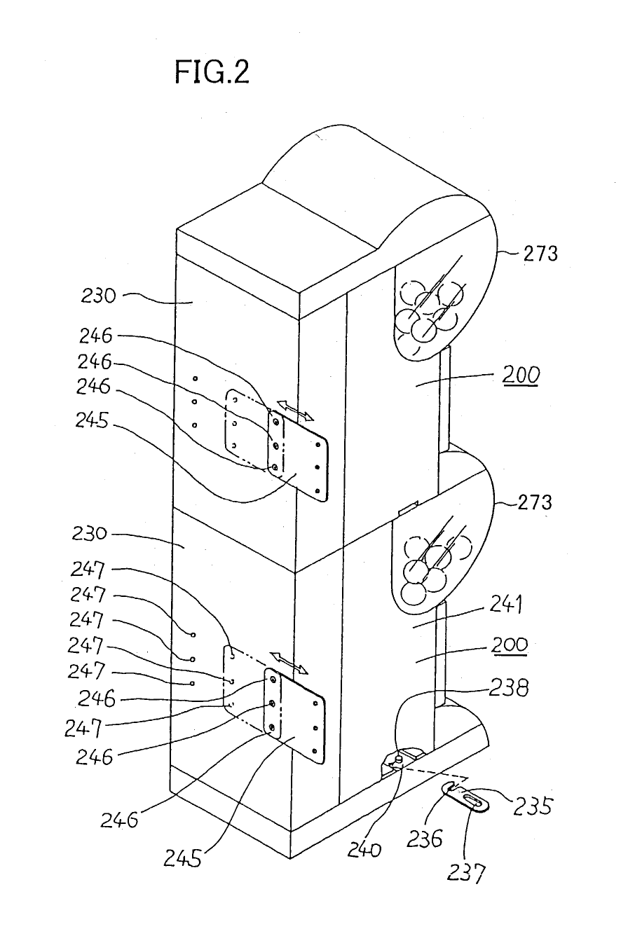

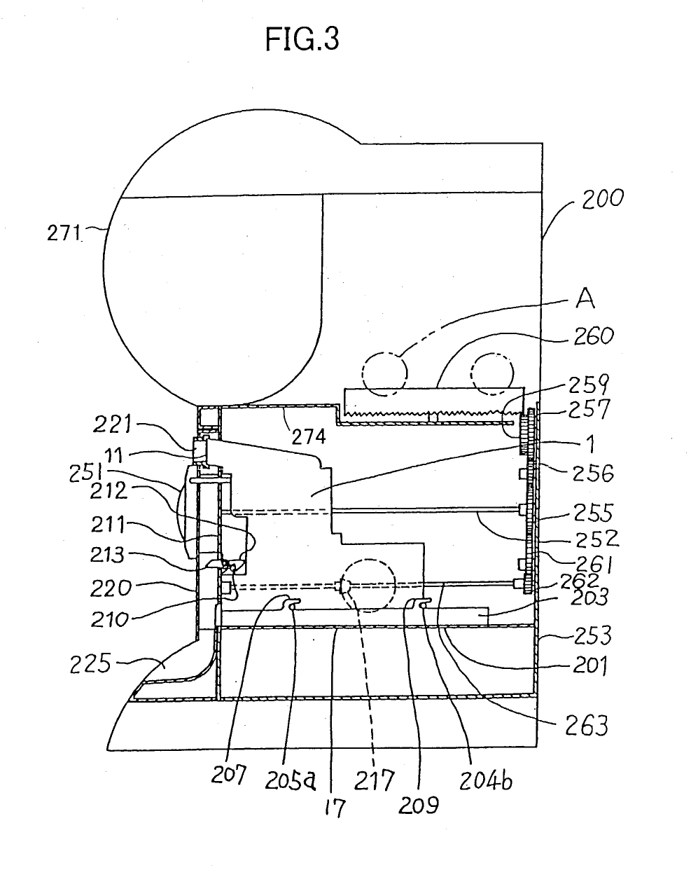

Referring to FIGS. 1 and 2, now described will be a manual vending machine that has a preferred embodiment of a coin detection apparatus according to the present invention. FIG. 1 is an anterior perspective view showing the manual vending machine that has the embodiment of the coin detection built in, FIG. 2 is a posterior perspective view showing the manual vending machine that has the coin detection apparatus built in, and FIG. 3 is a vertical sectional view illustrating an inside configuration of the same.

In FIGS. 1 and 2, by way of example only, there can be seen a vertical twin model of vending machine modules 200 where one module stacked over another. The upper module 200 has a box-shaped cabinet 230 that is comprised of almost planar rear, lateral, and bottom faces while the lower module 200 also has a box shaped cabinet 230 that is comprised of almost planar top, rear, lateral, and bottom faces. The upper module 200 is stacked over the lower module 200, having its bottom face registered with the top face of the lower module 200.

Both the modules 200 have their respective cases 273 containing items A. The modules 200 also respectively have cover panels 220 hinged in front to open and close the modules.

Each of the cover panels 220 includes an aperture 272 for a rotary handle 251, a coin drop 221, an aperture 271 for a trigger push button 71 of the coin detection apparatus, an item pickup 270, and a coin tray 225. When the cover panel is closed, the aperture 272 is loosely fitted on the rotary handle 251, the coin drop 221 is closely opposed to a coin shoot inlet 11 of the coin detection apparatus as described below, the aperture 271 is loosely fitted on the trigger push button 71, and the coin tray 225 is almost contiguous to a coin return exit 15 of the coin detection apparatus. The coin shoot inlet 11 receives coins deposited by a customer who wants to purchase an item A. The trigger push button 71 is depressed by the customer if he or she wants the coins deposited into the coin shoot inlet 11 to be returned. Depression of the trigger push button 71 permits the customer to recollect the deposited coins evacuated to the coin tray 225. The rotary handle 251 is used, after a predetermined number of coins are deposited by the customer, to take the item A at the item pickup 270.

In the posterior of each of the manual vending machine module 200, screw holes 247 are defined to fix a coupling plate 245. In this case, for instance, there are three of the screw holes 247 for the single coupling plate 245 which also has six bores. The screw holes 247 and the coupling plate 245 can be utilized together, having the three bores at one end of the coupling plate 245 registered with the three screw holes in the posterior of the module 200, to fix the coupling plate 245 to the manual vending machine module 200 with screws 246. Having the three bores at the other end of the coupling plate 245 registered with the three screw holes 247 in the posterior of the module 200, the identical coupling plate 245 can be fixed to another module of the manual vending machine 200 with the screws 246. In this way, two of the manual vending machine modules can be coupled and fixed side by side to each other, thereby facilitating a stable setting of many of the manual vending machine modules.

When the manual vending machine modules are not settled in stores, for example, during stages such as shipment and delivery, the coupling plates 245 may be respectively moved in a direction of arrows in FIG. 2 and then be attached to the manual vending machine modules within their respective posteriors by using the screws 246. This enables the manual vending machines modules 200 to be compact without flaps of the coupling plates 245 during the above-mentioned stages of shipment and delivery.

The lower module 200 has its one of the lateral faces 231 provided with a guide groove 232 at its lower portion, which extends almost orthogonal to the lateral faces 231. In the guide groove 232, a hook 235 is placed so as to be movable in the direction identical to an extension of the groove. The hook 235 has its one end formed in a U-shaped notch 236 and its other end formed with an elliptical hole 237 in the direction identical to the extension of the groove. The hook 235 is slidable due to the elliptical hole 237 which is fitted on a protrusion extending from the guide groove 232. The hook 235 variably extends out of the one of the lateral faces 231 of the box-shaped cabinet 230 within a range determined by the protrusion stopped at the opposite ends of the elliptical hole 237, respectively.

Similarly, as shown in FIG. 2, the lower module 200 may have the other of the lateral faces 231 provided with an aperture 240 in its lower portion so that the hook 235 of the different lower module 200 can be inserted therein. There is a projection (stake) 238 in the aperture 240, and the hook 235 having the U-shaped notch 236 detachably snaps the stake 238.

When two of the manual vending machine modules are set side by side, the hook 235, pulled from one of the modules, as can be seen in FIG. 1, is used to snap the stake 238 of the other module to fit its notch 236 thereon, as will be recognized in FIG. 2. In this manner, the two of the manual vending machine modules can be coupled and fixed to each other, thereby facilitating a stable settlement of the modules.

A reference is made to FIG. 3 that illustrates an inner structure of the manual vending machine module. In this drawing, there is shown an example of the inner structure of the upper module of the vertical twin model where two of the modules are stacked one over another.

The rotary handle 251 has its rotation center connected with one end of a rotation shaft 252. The other end of the rotation shaft 252 is connected to a rotation center of a spur gear 255 that is rotatably attached to a rear wall 253. A small gear 256 is rotatably positioned above and in engagement with the spur gear 255 in the rear wall 253. An additional spur gear 257 is rotatably positioned above ad in engagement with the small gear 256 in the rear wall 253. The spur gear 257 is superposed with a concentric drive gear 259.

Over part of a middle division wall 274 extending below the case 271, a turn table 260 is rotatably placed. A bottom face of the turn table 260 is crenellate so as to be engaged with the spur gear 257. The turn table 260 has several holes each of which is dimensioned larger than the item A, and in some position registered with the holes of the turn table 260, the division wall 274 has a through-hole (not shown) leading to the aforementioned item pickup 270. This enables the item A in one of the holes of the turn table 260 to be sent to the item pickup 270 when the hole gets registered with the through-hole in the division wall 274.

Another spur gear 261 is rotatably positioned below and in engagement with the spur gear 255 in the rear wall 253. A small gear 262 is further positioned below and in engagement with the spur gear 261 in the rear wall 253. The small gear 262 has its rotation center connected with one end of a middle shaft 263. The other end of the middle shaft 263 is rotatably attached to a front wall 211. In almost the middle of the middle shaft 263, a bevel gear 271 is coaxially placed.

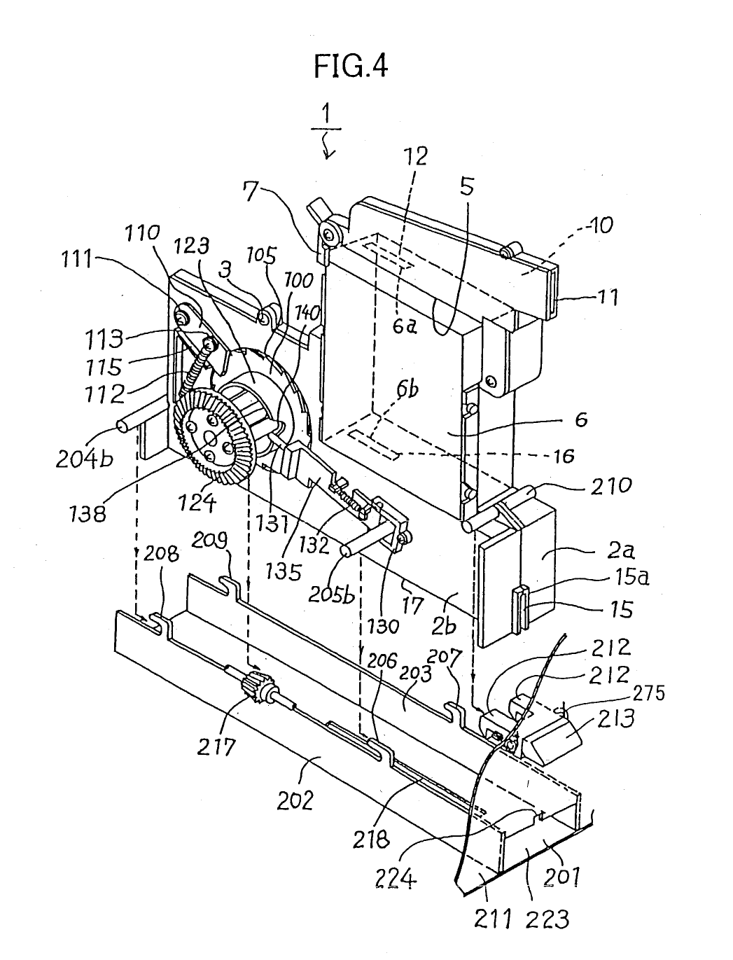

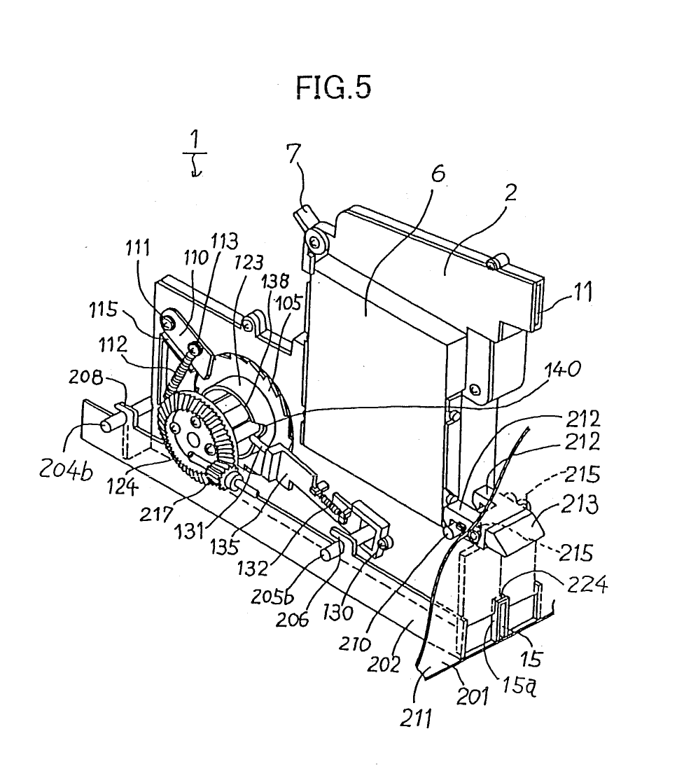

For either of the upper and lower vending machine modules, below the middle shaft 263 and over a division wall 201, a convex space is defined by horseshoe-like surrounding elements of a pair of vertical guide walls 202 and 203 extending at opposite ends of the division wall. The convex space elongates along a longitudinal extension of frame members 2a and 2b of the coin detection apparatus 1. In other words, the convex space elongates fore and after in the vending machine module, and hence, coins falling from the coin detection apparatus 1 is further dropped through an elongated hole 218 (mentioned hereinafter) defined in the horizontal division wall 201. In this case, the coin detection apparatus 1 may be detachably applied to the cabinet 230 and the guide walls 202 and 203. The manner of application of the coin detection apparatus 1 to the manual vending machine 200 will be further detailed with reference to FIGS. 4 and 5.

Coin Detection Apparatus

FIG. 4 is a left side perspective view showing an embodiment of the coin detection apparatus according to the present invention while FIG. 5 is a perspective view showing the coin detection apparatus in FIG. 4 installed in the manual vending machine.

As shown in FIGS. 3 to 5, the coin detection apparatus 1 can be detachably applied to the manual vending machine module 200. More specifically, the pair of plate-like guide walls 202 and 203 extend from the division wall 201, major surfaces of the former being almost in parallel with each other and approximately perpendicular to a major surface of the latter. The guide wall 202 (or 203) has its upper end provided with two crooked projections 206 (207) and 208 (209) at a predetermined interval between them. The crooked projections 206 and 207 are opposed to each other, and so are the crooked projections 208 and 209. The front wall 211 of the module 200 has a lock lever 213 that is rotatable about the rotation shaft 275. The lock lever 213 has a claw of two nails 212 that are urged by spring (an elastic element) so as to have an engagement (to go downward in the drawings). The front wall 211 has an opening 223 having a dent 224.

As a whole, the coin detection apparatus 1 is configured in an assembly of the right and left frame members 2a and 2b. The left frame member 2b includes cylindrical or columnar elements 204b and 205b that are perpendicular to a major surface of the left frame member 2b or to a left side face of the coin detection apparatus 1 to serve as engagement components. A distance from the element 204b to the element 205b is equal to the interval between the crooked projections 208 and 206.

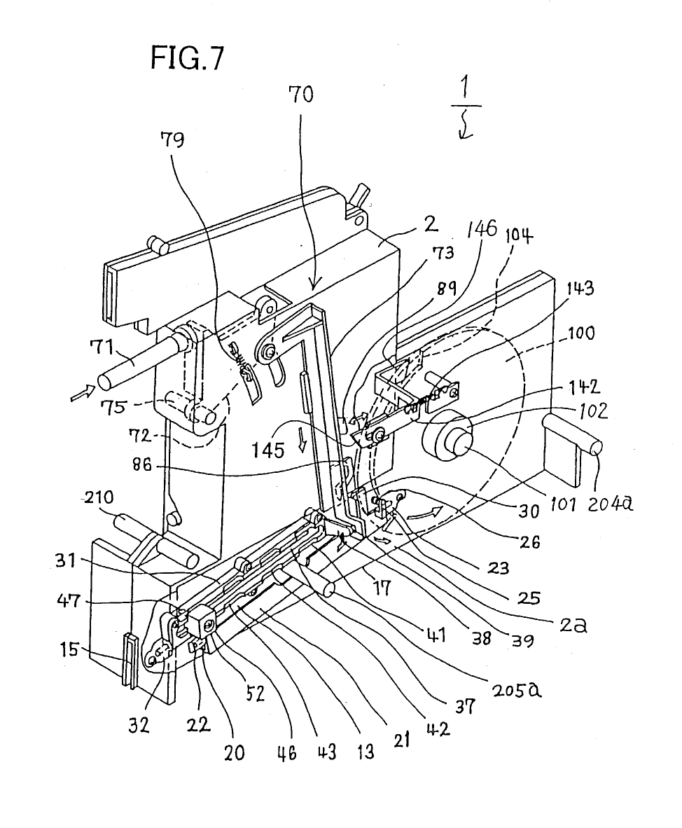

The right frame member 2a includes cylindrical or columnar elements 204a and 205a (see FIG. 7) that are perpendicular to a major surface of the right frame member 2a or to a right side face of the coin detection apparatus 1 to serve as engagement components. A distance from the element 204a to the element 205a is equal to the interval between the crooked projections 209 and 207.

The right and left frame members 2a and 2b have their respective cylindrical or columnar elements 210 that are respectively perpendicular to the major surfaces of the right and left frame members 2a and 2b to serve as engagement components. All the parts and elements serving as engagement components are perpendicular to any vertical plane extending fore and after along the frame members of the coin detection apparatus.

Configured as stated above, the coin detection apparatus 1, in installing the manual vending machine module 200, after having its lower portion inserted between the guide walls 202 and 203, is slid forward or toward the front wall 211 along the extension of the convex space 201. In this way, the engagement elements 204b, 205b, 204a and 205b are fitted in the crooked projections 208, 206, 209 and 207, respectively, while the engagement elements 210 are caught by the claw nails 212 of the lock lever 213, to instantaneously complete an automatic positioning, so that the coin detection apparatus 1 is fixed in the manual vending machine module 200 as shown in FIG. 5. In this situation, a raised portion 15a of the coin detection apparatus 1 is fitted in the dent 224 of the opening 222 in the front wall 211.

In removing the coin detection apparatus 1 from the module 200, the lock lever 213 is forced against the spring 215 to release the engagement elements 210 from the claw nails 212. In this situation, simply moving the assembly 2 of the coin detection apparatus backward, the engagement elements 204b, 205b, 204a, and 205a can all be released from the crooked projections 208 and 206 of the guide wall 202 and from the crooked projections 209 and 207 of the guide wall 203, respectively. In this manner, the assembly 2 of the coin detection apparatus can be easily detached from the module.

An exemplary structure of the coin detection apparatus 1 will now be detailed with reference to FIGS. 4 and 5. Referring to FIG. 1, the assembly 2 is, as a whole, comprised of the right and left frame members 2a and 2b which are made of material such as rigid synthetic resin or the like. The right and left frame members 2a and 2b are connected and fixed to each other by means of a coupling element such as a screw 3. A clearance slightly wider than a coin C is left between the right and left frame members 2a and 2b coupled together in the assembly.

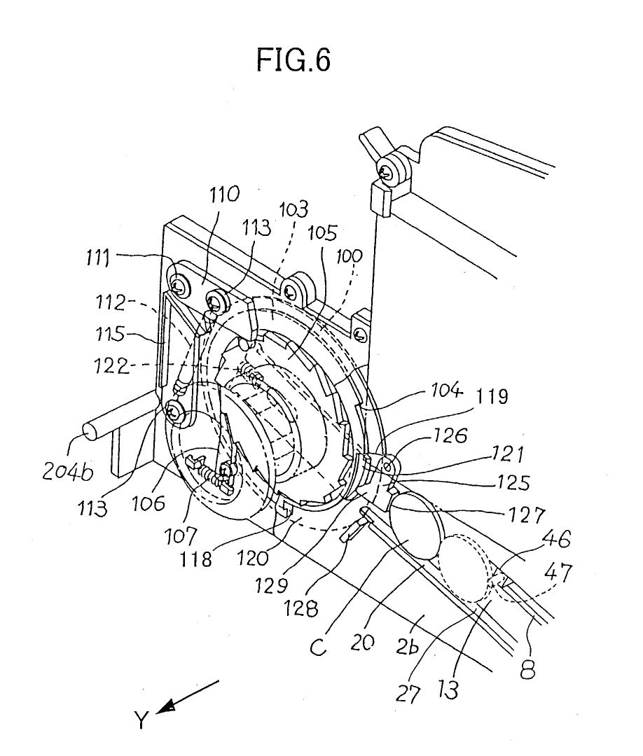

The assembly 2 is primarily comprised of an upper coin shoot, a coin selector 6 located in the middle and housed in a dent 5, a lower coin shoot 13 (see FIG. 6), and a rotation disk located in the posterior and rotated by the bevel gear 217 that transmits turning motion from the rotary handle. The upper and lower coin shoots 10 and 13 together mainly define a passage of coins.

The upper coin shoot 10 has a width slight larger than a thickness of the coin C and a height slightly larger than a diameter of the coin C so that the coin C can pass the shoot while it keeps upright or it has opposite sides kept almost orthogonal to a horizontal plane. The upper coin shoot 10 communicates between the coin snoot inlet 11 and a coin shoot outlet 12 and is inclined to make a depression from the coin shoot inlet 11 to the coin shoot outlet 12. In this manner, the coin C deposited through the coin shoot inlet 11 rolls by its own weight down to the coin shoot outlet 12 which is contiguous to an inlet 6a of the coin selector 6.

The coin selector 6 is detachably housed in the dent 5 in the assembly 2 and is fixed by a lock member 7 provided in an upper end of the assembly 2 so as to avoid an adverse release from the dent 5. The coin selector 6 can detect if the coin deposited is valid (e.g., a 100-yen coin). The coin selector 6 may be any of models well known in the art. The coin selector 6 has the inlet 6a at its top proximal to a rear edge and also has an outlet 6b at its bottom proximal to a rear edge in communication with the inlet 6a. The coin selector 6 further has a return (not shown) at the bottom proximal to a front edge in communication with the inlet 6a. Only coins selected as being valid among the coins C passed through the inlet 6a are sent to the outlet 6b while invalid coins are sent to the return. The return is communicated with the coin return exit 15 described below. The outlet 6 is contiguous to a coin receiver 16 in the lower coin shoot 13.

The lower coin shoot 13 communicates between the coin receiver 16 and the coin return exit 15; for example, it is inclined to make a depression from the coin receiver 16 to the coin return exit 15. A square gate-like ridge 15a surrounds the coin return exit 15. Beneath the lower coin duct 13 or in the bottom face of the assembly 2, the clearance between the right and left frame members 2a and 2b is left open without being blocked so as to define a coin drop 17. The coin drop 17 is contiguous to the elongated hole 218 in the division wall 201. As mentioned later, there is a bank box (not shown) beneath the elongated hole 218 to keep coins. Reference will further be made to FIGS. 6 to 8 below to detail the lower coin shoot.

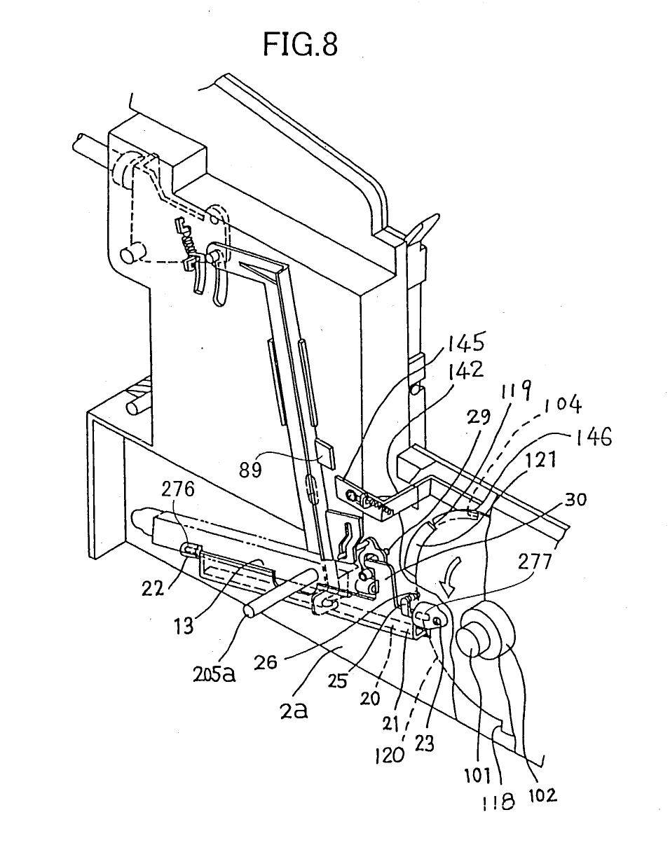

FIG. 6 is a perspective view showing an enlarged primary portion of the coin detection apparatus in FIG. 4. FIG. 7 is a light side perspective view of the coin detection apparatus in FIG. 4. FIG. 8 is a perspective view showing an enlarged primary portion of the coin detection apparatus in FIG. 7.

The lower coin shoot 13 is primarily defined, as can be seen in FIG. 6, by a floor plate 20 that extends from the outer surface of the right frame member 2a and protrudes through an elongated bore 27 (through-hole in the right frame member 2a) into the assembly 2. The coins C passed through the outlet 6b of the coin selector 6 stand on their depthwise surfaces or their circumferential surfaces along the floor plate 20, and their rolling is interrupted by a shaft 47 of a blocker 46 described below. When there are several of the coins C left in the lower coin shoot 13, the coins C stand upright on the floor plate 20. One of the coins staying closest to the coin return exit 15 first bumps on the shaft 47 of the blocker 46 and stops rolling and is followed by the coins that lean on the one right before, and consequently, all the coins C stay still on the floor plate 20. The floor plate 20 is made of a strip wider than a thickness of the coin C. As can be seen in FIGS. 7 and 8, a strip of attachment panel 21 is fixed to the floor plate 20, having almost the same length as that of the floor plate 20. As will be recognized in the drawings, the attachment panel 21 is fixed, having its major surface kept approximately orthogonal to the major surface of the floor plate 20. The floor plate 20 and the attachment panel 21 are assembled in unit, and the integral unit of the floor plate 20 and the attachment panel 21 is approximately L-shaped in vertical cross section seen forward on the posterior of the assembly 2.

The attachment panel 21 belongs to a lower portion of the right frame member 2a so that the floor plate 20 extends out of the elongated bore 27 which tilts down as it closer to the anterior of the right frame member 2a. The elongated bore 27 should be greater in length and thickness than the floor plate 20.

For instance, the attachment panel 21 has two round bar-like projections 276 and 277 positioned on opposite ends of an upper side of the attachment panel 21, with extensions of their respective center axes being almost aligned with each other, and it also has a spring support 25 that is located proximal to one end of the upper side of the attachment panel 21 and extends upward beyond the center axis of the projections. In the outer surface of the right frame member 2a and above the elongated bore 27, two bearings 22 and 23 are provided, having their respective center axes almost in parallel with a longer extension of the elongated bore 27. The bearings 22 and 23 include holes which are longer in diameter than the projections 276 and 277 of the attachment panel 21, respectively. After the projections 276 and 277 of the attachment panel 21 are inserted into the holes of the bearings 22 and 23 of the right frame member 2a, respectively, the floor plate 20 integral with the attachment panel 21 is set in position through the elongated bore 27, and a spring member 26 is also set in position between the spring support 25 and the right frame member 2a. Thus, the attachment panel 21 and the floor plate 20 can pivot in a widthwise direction relative to coins supported on the lower coin shoot 13.

Configured as mentioned above, the attachment panel 21 is elastically forced by the spring member 26 against the spring support 25 to pivot about the projections 276 and 277 toward the elongated bore 27 (see FIG. 8). Thus, the floor plate 20 contiguous to the attachment panel 21 normally extends through the elongated bore 27 and protrudes into the assembly 2.

Referring to FIG. 6, when force is applied, in a direction from the inside of the assembly 2 to the right frame member 2a, to the floor plate 20 protruding into the assembly 2, the floor plate 20 repels elastic force of the spring member 26 and retracts from the assembly 2. Since the floor plate 20 moves to release the coins standing thereon, the coins C staying in the lower coin shoot 13 fall to the coin drop 17.

When the blocker shaft 47 is fixed in a position as depicted by broken line to enable more than one coins C to stay on the floor plate 20 as depicted by solid and broken lines, the coins C stand upright, having their respective circumferential surfaces kept in contact with the floor plate 20. In such a state, when the floor plate 20 moves in the widthwise direction to release the coins, the coins C lost support altogether almost at once and fall to the coin drop 17. In other words, once moving to retract, the floor plate 20 let the coins C in the lower coin shoot 13 go as gravity force pulls them.

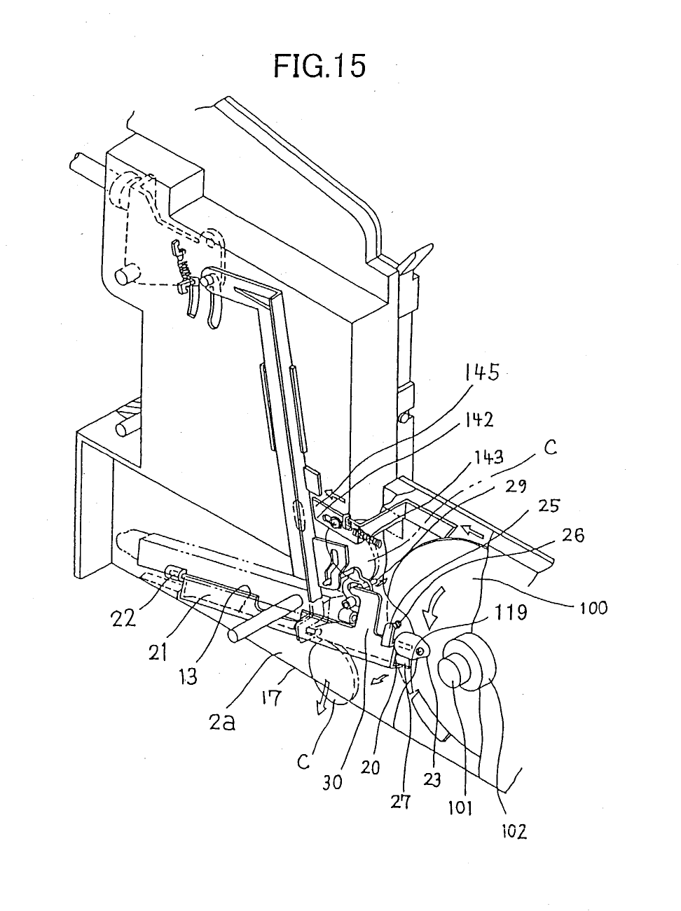

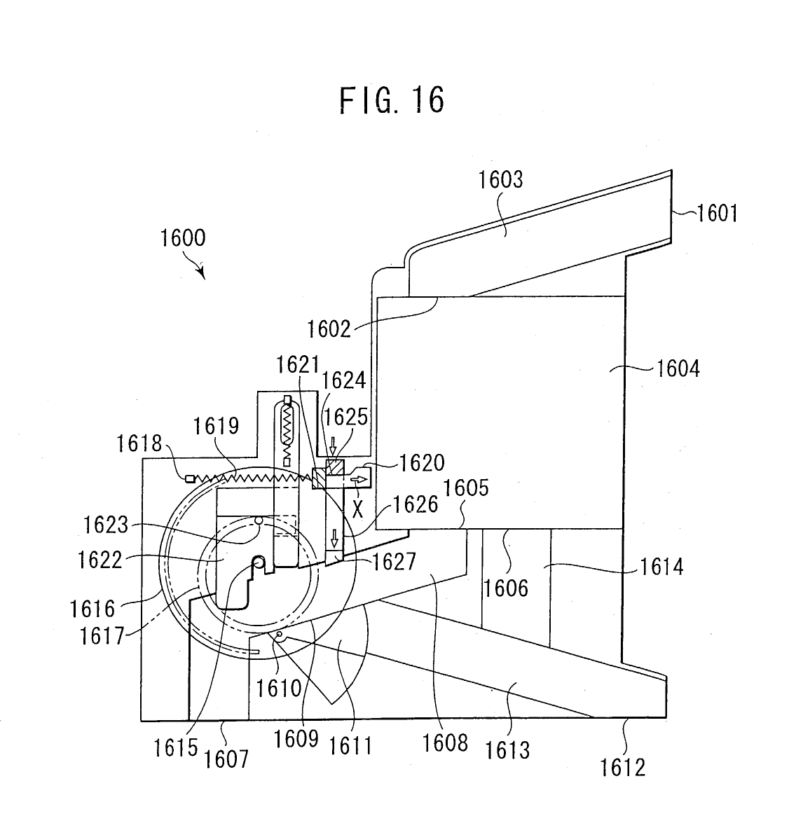

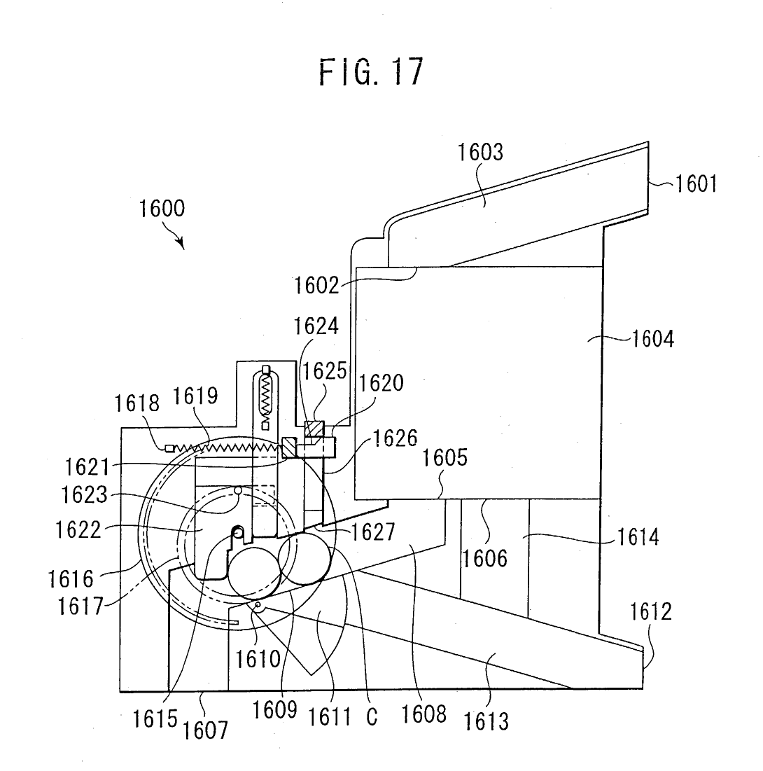

Referring to FIG. 8, the attachment panel 21 also has a swing piece 30 located in one end of the upper side thereof above the center axes of the projections 276 and 277, and such a swing piece may, in this case, extend upward beyond the spring support 25. The swing piece 30 is, for example, shaped like a flap that extends from the attachment panel 21 and has a major surface approximately in parallel with that of the attachment panel 21. The swing piece 30 has a round rod-like coin stop pin 29 for preventing a coin from dropping, which extends from a face opposed to the right frame member 2a (see FIG. 15 described hereinafter) and is perpendicular to the face. In a corresponding position, the right frame member 2a has a hole sufficiently large to let the coin stop pin 29 extend through. In the situation where a prescribed number of the coins C are held in the lower coin shoot 13, the hole is positioned between an upper edge of the coin pushed by a contact piece 125 (see FIG. 6) and the coin receiver 16 in the lower coin shoot 13.

In this way, the coin stop pin 29 would not extend through the hole and protrude into the assembly 2 while the floor plate 20 is elastically urged by the spring member 26 and protrudes into the assembly 2, but instead, the coin stop pin 29 extends through the hole and protrudes into the assembly 2 while the floor plate 20 repels elasticity of the spring member 26 and retracts from the assembly 2. Thus, as mentioned below, when more than the prescribed number of the coins C have been deposited, any coin other than those in the lower coin shoot is prevented from falling into the coin drop 17. If the same effect can be attained, the hole and the coin stop pin 29 many be provided in any position to inhibit more than the prescribed number of the coins from entering the lower coin shoot 13 with the coin stop pin 29 protruding out of the hole into the assembly 2. The lower coin shoot will be described in detail below.

Coin Return Mechanism

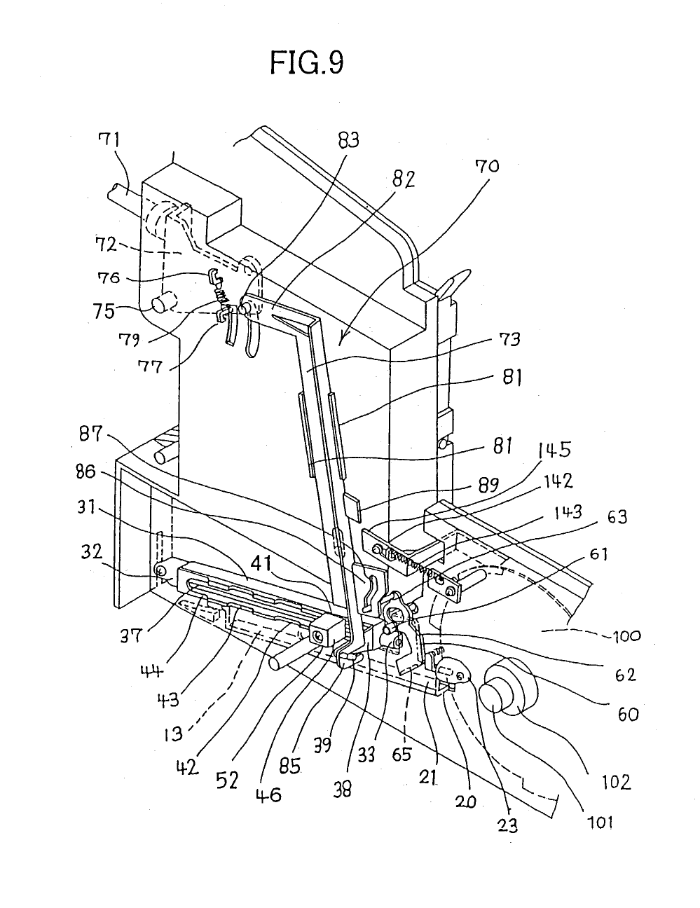

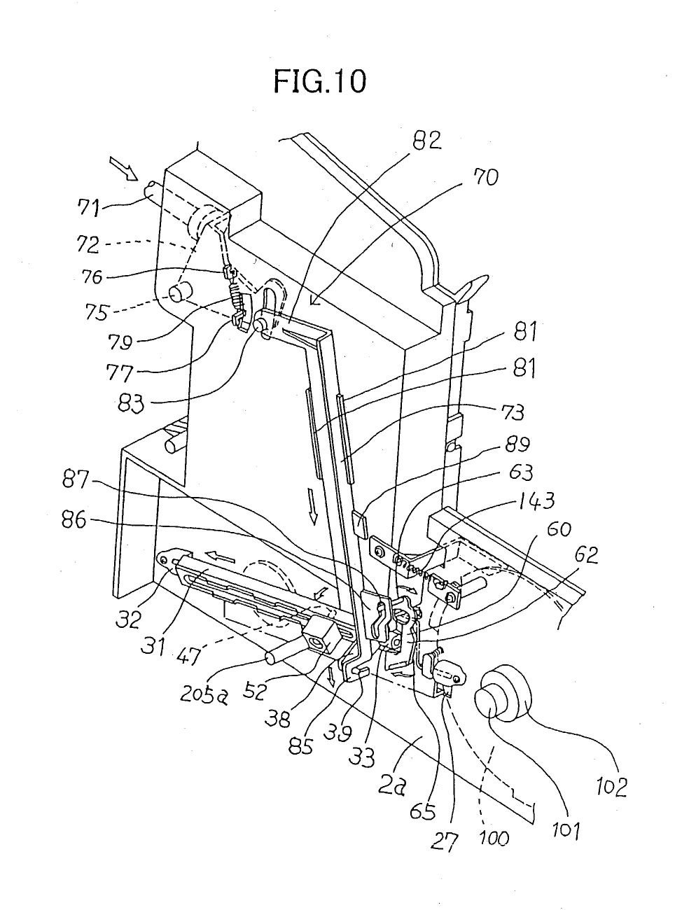

Referring to FIGS. 9 and 10, discussed will be a mechanism incorporated mainly in the right frame member 2a, which functions to return coins. FIGS. 9 and 10 are perspective views showing an enlarged major portion of the coin detection apparatus in FIG. 7.

In FIG. 9, a trigger push bar 71 is provided in an upper portion of the right frame member 2a. The trigger push bar 71 is cooperatively coupled with a piece 72 that is fixed to the right frame member 2a so as to pivot about a fulcrum shaft 75. The piece 72 has a hook 77 in one of surfaces facing the right frame member 2a. Another hook 76 is provided in the right frame member 2a, and when the trigger push bar 71 is in normal position, the hook 76 is above the hook 77 in the piece 72. A spring member 79 has its opposite ends fixed to both the hooks 76 and 77. Elastic force of the spring member 79 urges the piece 72 to pivot about the fulcrum axis 75 toward the trigger push bar 71 (e.g., in a counterclockwise direction in FIG. 9); that is, the piece 72 pushes the trigger bar 71 back to make it pop up.

The piece 72 is coupled to an arm link 73. The arm link 73 has primary effectors including a head 82 bent at the top, an approximately U-shaped hook 85 at the bottom, a grooved flap 86 above the hook 85, and a middle stopper thrust 89, and the U-shaped hook 85 has its major surface perpendicular to an elongated intermediate flat shaft of the arm link 73. The head 82 of the arm link 73 is coupled to the piece 72 by a frustum axis 83 so as to pivot about it. The right frame member 2a is provided with two guide ridges 81 spaced slightly wider than a width of the arm link 73. The guide ridges 81 are almost in parallel with a longitudinal extension of the arm link. In this manner, pivotal movement of the piece 72 allows the arm link 73 to move along its elongation.

The flap 86 has a guide groove 87 that extends vertically but is wound backward as it runs upward relative to the right frame member 2a. A pusher 60 is fixed to the right frame member 2a close to the flap 86 by a fulcrum axis about which it can pivot. The pusher 60 is primarily comprised of a swing piece 62 pivotally fixed by the axis 61, a slide pin 63 fixed at an upper end of the swing piece 62, and a push end 65 located at a lower end of the swing piece 62 and floating between the right frame member 2a and the attachment panel 21. The push end 65 has its free end passed through an opening defined in the right frame member 2a and projected into the lower coin shoot 13. The slide pin 63 is fitted in the guide groove 87 in the flap 86 of the arm link 73.

In the context of such a configuration as has been mentioned, referring to FIGS. 9 and 10 for the purpose of comparison, depressing the trigger push bar 71 first causes pivotal movement of the piece 72, and this results in the arm link 73 moving downward along the guide ridges 81. This downward movement of the arm link 73 makes the slide pin 63 in the guide groove 87 permit the pusher 60 to pivot about the axis 61 (i.e., in a clockwise direction in FIG. 9). This forces the push end 65 to move forward relative to the right frame member 2a, and as a result, the free end of the push end, as it protrudes into the lower coin shoot 13, push the coins on the floor plate 20 in the lower coin shoot 13 toward the coin return exit 15.

The hook 85 of the arm link 73 is fitted on part of a guide member 31 provided in a lower portion of the outer surface of the right frame member 2a. In the following discussion, the guide member 31 will be embodied, where prior to an explanation of how the guide member 31 is attached to the right frame member 2a, an arrangement of the guide member 31 itself will first be described.

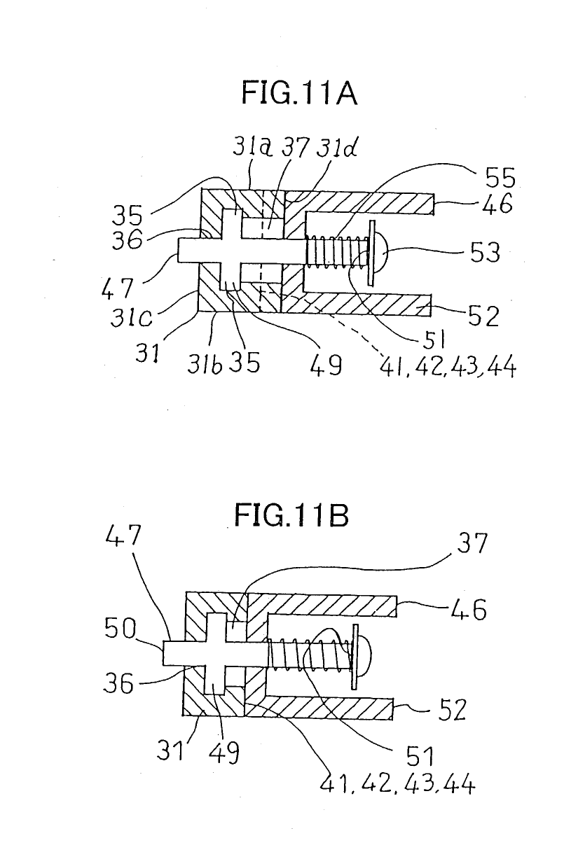

FIGS. 11A and 11B are sectional views showing an exemplary arrangement of the guide member 31 that is built in the preferred embodiment of the coin detection apparatus according to the present invention. Referring to FIGS. 9 to 11, the guide member 31 is shaped like an empty rectangular parallelpiped. Among four longitudinal sides, a top surface 31a and a bottom surface 31b are almost in parallel with each other. A left surface 31c of the remaining longitudinal sides, which faces the right frame member 2a, is almost planar, but a right surface opposite to the left surface 31c is shaped in an irregular plane, having many recessed portions.

Specifically, the left surface 31c has a long groove 36 that extends longitudinally. The top and bottom surfaces 31a and 31b respectively have guide grooves 35 of a predetermined width. The right surface 31d also has a long hole 37 that extends longitudinally. In the remaining part of the right surface 31d, there are four dents 41, 42, 43 and 44 of a predetermined width that are lined above and below the hole 37, respectively, to serve as position markers.

The guide member 31 has a blocker 46 that can be slid and fixed in position. The blocker 46 is primarily comprised of a shaft 47 extendable in the groove 36 and the hole 37 in the guide member 31, a rectangular parallelpiped locating member 52 having a cylindrical cavity inside, and a spring member 55. The blocker shaft 47 has a first end 50 dimensioned to be inserted in the groove 36 of the guide member 31, a sliding member 49 perpendicular to the first end 50 and capable of sliding in the guide grooves 35 of the guide member 31, and the other (second) end 51 machined in a sems 53. The locating member 52 has a contact face that is orthogonal to its longitudinal faces and has a width slightly shorter than that of each of the dents 41, 42, 43 and 44 so as to be fitted in any one of them, and the contact face of the locating member 52 with the dents includes an opening through which the blocker shaft 47 is extendable.

As can be seen in FIG. 8, once the blocker 46 is attached to the guide member 31, the blocker shaft 47 has the one end 50 extended in the groove 36, the sliding member 49 being fitted in the guide grooves 35, while it keeps the other end 51 extended out of the hole 37. The locating member 52 has its one side or the contact face fitted in any one of the dents (e.g., the dent 41 in FIG. 9) in the guide member 31, with the second end 51 further extending out of the opening. Elastic force of the spring member 55 over the sems 53 affects the locating member 52. This usually urges the locating member 52 to settle itself in any dent of the guide member 31. When force is applied in a direction apart from the guide member 31, the locating member 52 is released from the dent. In such a state, applying force in any of lateral directions enables the locating member 52 to permit the sliding member 49 of the blocker shaft 47 to move along the guide grooves 35 in the guide ember 31. Stopping an application of such force in the direction apart from the guide member 31, the locating member is urged to fit in any of the dents in the guide member 31. Thus, in FIG. 9, the blocker 46 can be settled in any of the dents 41 to 44.

Also, as will be recognized in FIG. 9, the guide member 31 has projections extending from faces that are orthogonal to the longitudinal lateral faces. One of the orthogonal faces of the guide member 31 (i.e., the posterior face relative to the right frame member 2a in FIG. 9) has an arm piece 38 along its parallel elongation. The arm piece 38 includes a round bar-like pin 39 extending almost in parallel with the longitudinal extension of the guide member 31.

Returning to FIGS. 9 and 10, it will be discussed how to attach the aforementioned guide member 31 to the right frame member 2a. As can be seen in FIG. 6, the right frame member 2a has a long aperture 8 that is defined almost in parallel with the floor plate 20 and is wider than the shaft 47 of the blocker 46. To the right frame member 2a configured in this form, the guide member 31 is attached, with its longitudinal extension being approximately in parallel with the lower coin shoot 13 of the right frame member 2a. More specifically, the guide member 31 has its projections fitted in the bearings 32 and 33 of the right frame member 2a, and this allows the guide member 31 to rotate relative to the right frame member 2a. In this way, as in FIG. 6, the shaft 47 of the blocker 46 can extend out of the aperture 8 into the lower coin duct 13 in the right frame member 2a. As the blocker 46 settles itself from one dent to another as required in the guide member 31, the shaft 47 of the blocker 46 also varies its position where it extends into the lower coin shoot 13. Specifically, as the blocker 46, as in FIG. 9, changes its position of settlement successively from the dent 41 to the dent 44 in the guide member 31, accordingly the shaft 47 of the blocker 46, as in FIG. 6, moves toward the coin return exit 15. In other words, the shaft 47 of the blocker 46 can move on a trajectory almost in parallel with line passing centers of the coins held in the lower coin shoot 13.

Assuming that the prescribed number of the coins is selected from 1 to 4, the blocker 46 is accordingly settled in the dents 41 to 44 of the guide member 31 so that 1 to 4 of the coins C can be stored in the lower coin shoot 13. The guide member 31 will be detailed below.

Coin Evacuator

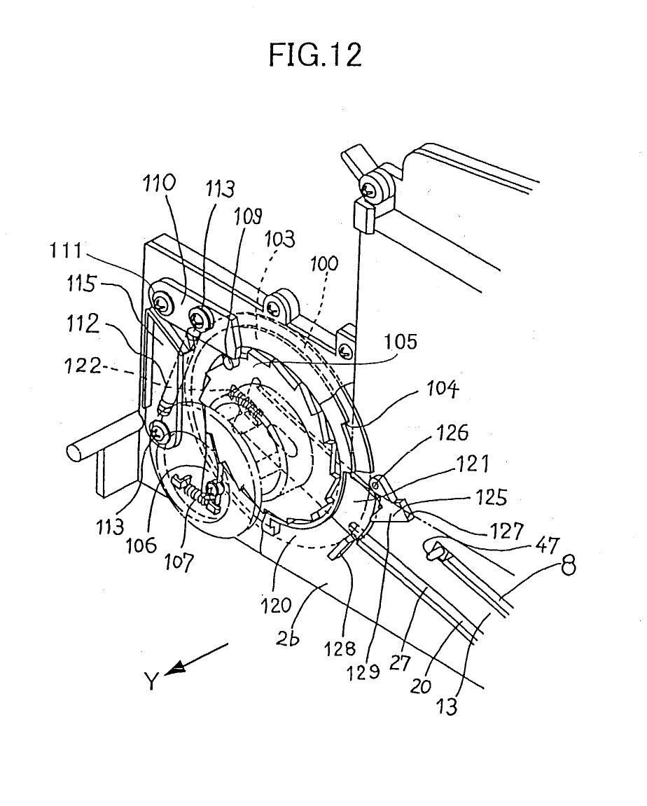

A mechanism of a coin evacuator attached to the left frame member 2b will now be described with reference to FIG. 12. FIG. 12 is a perspective view showing an enlarged major portion of the coin detection apparatus in FIG. 4. Returning to FIGS. 5 and 7 that have already been used above, a rotary disk 100 is positioned between the right and left frame members 2a and 2b, having its center axis 101 rotatably received by a bearing 102 that is provided behind the right frame member 2a. The rotary disk 100 is capable of rotating.

As shown in FIG. 12, an annular plate 103 is concentrically laid over the rotary disk 100 between the right and left frame member 2a and 2b. At the center of the annular plate 103, there is an opening slightly greater in diameter than a sawtoothed gear wheel 105 that is also laid over the rotary disk 100 in the left frame member 2b. The sawtoothed gear wheel 105 is also concentric with the rotary disk 100. A surface of the gear wheel 105 reached a level higher than an outer surface of the left frame member 2b. The sawtoothed gear wheel 105 includes a locating pin 109.

As can be seen in FIG. 5, a cylindrical cam 123 is placed on the sawtoothed gear wheel 105 and is also concentric with the rotary disk 100. Over the cylindrical cam 123, a bevel gear 124 engaged with the aforementioned bevel gear 217 is provided to serve as an input gear, and the bevel gear is also concentric with the rotary disk 100.

Referring to FIG. 12, there is provided in the left frame member 2b a stopper nail 106 that is urged by a spring member (elastic member) 107. The stopper nail 106 comes in contact with the sawtoothed gear wheel 105 to permit the rotary disk to turn only in one way (in a clockwise direction in FIG. 12).

The left frame member 2b is also provided with a locating piece 110. The locating piece 110 is attached to the left frame member 2b at a center axis 111 about which the locating piece 110 can pivot. The locating piece 110 is connected with a spring member (elastic member) 112 at one end by a screw 113, and the other end of the spring member is fixed to the left frame member 2b by an additional screw 113. The locating member 110 is urged by the spring member 112 to pivot about the center axis 111 in the clockwise direction, and it bumps against the locating pin 109 on the sawtoothed gear wheel 105. A stopper piece 115 inhibits the locating piece 110 from pivoting in the counterclockwise direction. An initial position of the rotary disk 100 is a point where the locating piece 110 leans on the locating pin 109.

More significant points on the configuration of the rotary disk and the annular plate 103 will be further discussed in terms of components that are provided between the right and left frame members 2a and 2b and are engaged with the rotary disk 100 and the annular plate 103. For better understanding a positional relation among the components along with a directional relation from the right frame member 2a to the left frame member 2b (a direction denoted by an arrow Y in FIGS. 6 and 12), expressions such as “ . . . is at an elevating level as it goes in the Y direction . . . ” or “ . . . is a depressing level as it goes in the reverse direction to the Y direction . . . ”. The Y direction is almost perpendicular to major surfaces of the right and left frame members 2a and 2b.

A stopper piece 128 is provided in either the right frame member 2a or the left frame member 2b to reach the same level as the annular plate 103.

The rotary disk 100 reaches a lower level than the annular plate 103 but does almost the same level as the floor plate 20 protruding in the lower coin shoot 13. This would never let the rotary disk 100 contact the stopper 128. The rotary disk 100 has a recessed portion 120 in its outer circumferential area. The rotary disk 100 (the recessed portion 120 excluded) has a diameter as large as its chamfered edge can push the floor plate 20 protruding in the lower coin shoot 13 while the rotary disk is rotating. Thus, when rotation of the rotary disk 100 makes its outer circumferential area (the recessed portion 120 excluded) push the floor plate 20, the floor plate 20 repels the elastic force of the spring member 26 and retracts from the assembly 2, as mentioned above, and consequently, the coins C on the floor plate 20 fall to the coin drop 17.

The annular plate 103 has a diameter as large as it would not bump on the stopper piece 128 while rotating. Beneath the annular plate 103 provided is a piece 121 which is positioned to cover the recessed region 120 in the rotary disk 100 and which is capable of emerging outward beyond the edge of the annular plate 103. When the piece 121 extends along radial directions of the annular plate 103, it is urged by a spring member (elastic member) 122 to the same directions to spread out beyond the edge of the annular plate 103.

The piece 121 is at the same level as the stopper piece 128. Thus, although the annular plate 103 rotates in association with the rotation of the rotary disk 100, it no longer rotates after the piece 121 bumps and leans on the stopper piece 128. On the contrary, while the piece 121 retracts, it does not bump on the stopper piece 128, and hence, the annular plate 103 continues to rotate.

In the lower coin shoot 13, a pusher 125 is pivotally attached at a frustum shaft 126 to either the right frame member 2a or the left frame member 2b, as shown in FIG. 6, so as to push the piece 121. The pusher 125 is at the same level as the piece 121 and pushes it beneath the annular plate 103. The pusher 125 includes a contact face 127 that leans on a coin and a pusher piece 129 that pushes the piece 121.

Once, by virtue of blockage of the shaft 47 of the blocker 46, the prescribed number of the coins C are deposited in the coin shoot 13, the contact face 127 of the pusher 125 leans on the coin farthest from the coin return exit 15. This stops pivotal movement of the pusher 125. When the pusher 125 stops pivoting, the rotary disk 100 and thus the annular plate 103 rotate. If the annular plate 103 continues to rotate even after the pusher piece 129 of the pusher 125 contacts the piece 121, the pusher piece 129 causes the piece 121 to retract against elasticity of the spring member 122.

When the contact surface 127 accidentally leans on the coin for some reason without the predetermined number of the coins C in the lower coin shoot 13, the piece 121 pushes the pusher 125 while the rotary disk 100 is rotating, and this results in the coin being forced to the coin return exit 15. Thus, the pusher 125 serves to evacuate all the coins C from the lower coin shoot 13 to the coin return. Eventually the pusher 125 becomes pivotal again, and the piece 121 is left extended. This inhibits further rotation of the rotary disk 100. In other words, without the predetermined number of the coin C held in the lower coin shoot 13 because of the blocker shaft 47 and the pusher 125, the rotary disk 100 is not to rotate.

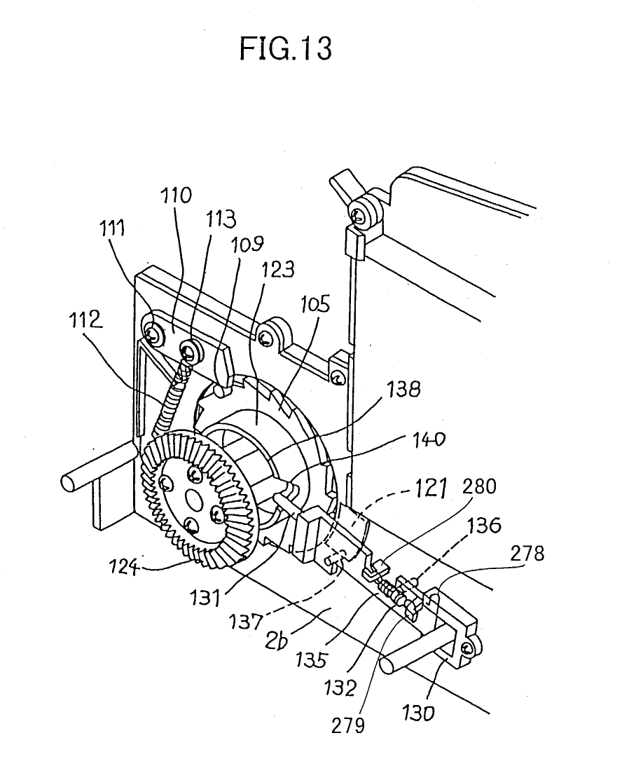

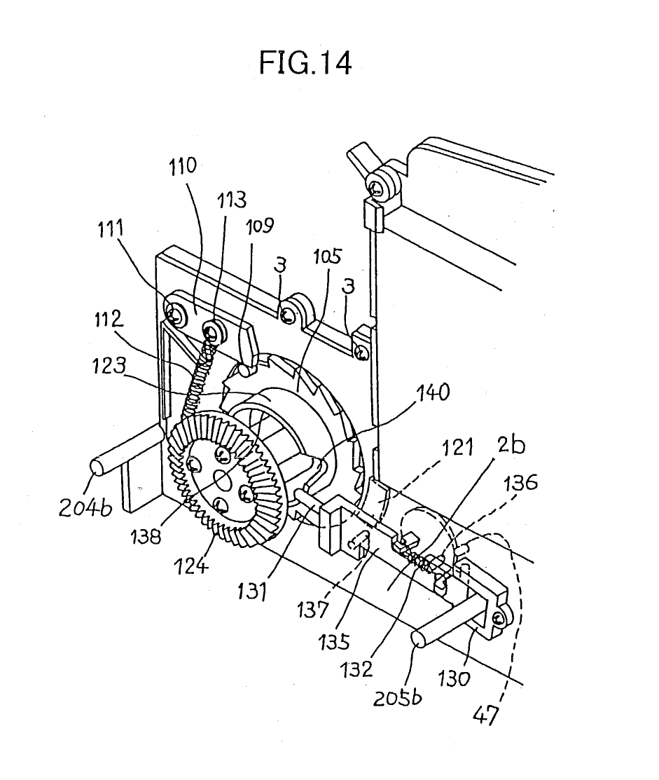

The cylindrical cam 123 is engaged with a slide pin 131 extending from a swing member 135 that is fixed to the outer surface of the left frame member 2b. A specific arrangement of the swing member 135 will be detailed below with reference to FIGS. 13 and 14 which are perspective views showing an enlarged major portion of the coin detection apparatus in FIG. 4.

The swing member 135 has a ridge 278 at one end. The ridge 278 is fitted in a joint (not shown) of a cornered horseshoe-like bearing 130 that is attached to the outer surface of the left frame member 2b, so that the swing member 135 can pivot about the ridge 278. There is also a hook 279 extending from the swing member 135 close to the ridge 278. At the other end of the swing member 135, the slide pin 131 extends and is engaged with a circumferential surface of the cylindrical cam 123.

The swing member 135 also has a contact pin 136 that extends from its side facing the left frame member 2b and is proximally fixed in a position where the coin farthest from the coin return exit 15 stays in the lower coin shoot 13 with the predetermined number of the coins C. The contact pin 136 passes through a first opening (not shown) defined in the left frame member 2b and protrudes into the lower coin shoot 13.

Moreover, the swing member 135 includes a stopper pin 137 that extends from the surface facing the left frame member 2b through a second opening (not shown) defined in the same and protrudes into an inner space of the same so as to stop the rotation of the rotary disk 100. The second opening is, for example, defined in the left frame member 2b in a position that the piece 121 reaches while it is not retracted, as shown in FIG. 13.

A hook 280 is fixed to the left frame member in a surface opposed to the swing member 135. A spring member (elastic member)

132 is provided between the hook 279 of the swing member 135 and the hook 280 of the left frame member 2b. Elastic force applied by the spring member 132 urges the swing member 135 toward the left frame member 2b.

In an end rim 138 of the cylindrical cam 123 engaged with the slide pin 131, there is an approximately wedge shaped notch 140.

Without the predetermined number of the coins C held in the lower coin shoot 13 in such a configuration, as will be recognized in FIG. 13, immediately after the rotary disk 100 begins to rotate, the slide pin 131, which slides on the end rim 138 of the cylindrical cam 123, is urged to drop in the notch 140 because the coin C does not push the contact pin 136 back; that is, a swing motion of the swing member 135 enables the stopper pin 137 to extend out of the second opening into the inner space of the left frame member 2b and block the extending piece 121 from rotating. Consequently, the rotary disk 100 stops rotating. On the contrary, as will be recognized in FIG. 14, once the predetermined number of the coins C are blocked by the block shaft 46 and held in the lower coin shoot 13, the slide pin 131 extending from the swing member 135, which slides on the end rim 138 of the cylindrical cam 123 immediately after the rotary disk 100 begins rotating, does not drop in the notch 140 since the coin farthest from the coin return exit 15 leans on the contact pin 136; that is, since no swing motion of the swing member 135 is taken place, the stopper pin 137 does not protrude into the inner space of the left frame member 2b nor block the rotation course of the extending piece 121, and nothing stops the rotation of the rotary disk 100.

In this embodiment, the swing member 135 is, by way of example, opposed to one major surface of the coin C in the lower coin shoot 13. However, the swing member 135 may be configured in any manner if it is urged to swing in widthwise directions relative to the coin shoot so as to have its contact pin 136 pushed back by one of the coins C and to make its stopper pin 137 block the piece 121 from rotating.

Also in this embodiment, in order to prevent the contact pin 136 from entering the lower coin shoot 13 and contacting one of the coins C, the cylindrical cam 123 has its end rim 138 shaped so that the swing member 135 is moved in a repelling direction from the major surface of the coin. However, any of other ways may be used to make the swing member 135 swing in the repelling direction from the coin in association with the rotation of the rotary disk 100. Similarly, in this embodiment, in order to permit the contact pin 136 to enter the lower coin shoot 13 and contact one of the coins C, the cylindrical cam 123 has the approximately wedge shaped notch 140 which is simply an exemplary means in association with the rotation of the rotary disk 100 to release the swing member 135 from an pushing force toward the coin. However, any of other ways may be used to leave the wing member 135 free from the pushing force in relation with the rotation of the rotary disk 100.

Finally, as can be seen in FIG. 6, the annular plate 103 also has a step 104. Besides FIG. 6, FIGS. 7 and 8 will be used to explain how the step 104 functions.

The right frame member 2a of the assembly 2 has a resist element 142 having a leading edge 145 and a trailing edge 146. The leading edge 145 is engaged with the stopper thrust 89 of the arm link 73 to prevent the arm link 73 from moving downward. The trailing edge 146 can be engaged with the annular plate 103. The resist element 142 is urged by a spring member (elastic member) 143 so that the element simultaneously has its leading edge 145 left apart from the stopper thrust 89 and its trailing edge 146 got engaged with the step 104 of the annular plate 103.

Configured as mentioned above, as the rotary disk 100 rotates, the trailing edge 146 of the resist element 142 is engaged with the step 104 of the annular plate 103. This results in the leading edge 145 of the resist element 142 moving to get engaged with the stopper thrust 89. Thus, while the rotary disk 100 is rotating, the stopper thrust 89 of the arm link 73 serves to inhibit pressing the trigger push bar 71 down. Specifically, while the trigger push bar 71 is depressed, the resist element 142 prevents the rotary disk 100 from rotating.

Functions of the Manual Vending Machine Having the Coin Detection Apparatus Built in

Functions of the manual vending machine having the above-mentioned coin detection apparatus will now be described. As shown in FIG. 1, turning the rotational handle 251 in front of the manual vending machine, first the spur gear 255 in the posterior wall 253 is rotated via the rotation shaft 252, as can be seen in FIG. 3. As the spur gear 255 rotates, the rotation is transmitted through the small gear 256 engaged with the spur gear 255, the spur gear 257 engaged with the small gear 256, and the drive gear 259 integrated with the spur gear 257 to rotate the turn table 260. This enables one of the items A in the holes of the turn table 260 to be taken at the item pickup 270.

Also, as the spur gear 255 rotates, the rotation is transmitted through the spur gear 261 engaged with the spur gear 255, the small gear 262 engaged with the spur gear 261, and the middle shaft 263 linked to the small gear 262 to rotate the bevel gear 217. The bevel gear 217 is engaged with the bevel gear 124 provided in the coin detection apparatus 1.

Coin Return

Return of coins will now be described. Assume that the predetermined number of coins for a specific value (i.e., the number of coins required to obtain the item A) is 1. When a single coin is required, as shown in FIG. 9, the locating member 52 of the blocker 46 is fitted in the dent 41 in the guide member 31.

When a customer deposits a coin C through the coin drop 221 into the coin shoot inlet 11, the coin falls through the upper coin shoot 10, the coin shoot outlet 12, the coin selector inlet 6a, the coin selector 6, the coin selector outlet 6b, and the coin receiver 16 till it drops in the lower coin shoot 13, as shown in FIG. 4. As can be seen in FIG. 6, since the shaft 47 of the blocker 46 blocks the lower coin shoot 13, the coin C is held still on the shaft 47.

Referring to FIGS. 9 and 10 for the purpose of comparison, once the trigger push bar 71 of a coin return mechanism 70 is depressed, the piece 72 pivots in the clockwise direction against elastic force of the spring member 79 to move the arm link 73 downward via the fulcrum axis 83. This causes the guide member 31 to pivot because of intervention of the pin 39 and the arm piece 38, which, in turn, causes the shaft 47 of the blocker 46 to pivot. Hence, the shaft 47 retracts from the lower coin shoot 13, and this results in the coin C blocked by the shaft 47 of the blocker 46 rolling by its own weight in the lower coin shoot 13 down to the coin return exit 15 at which the coin C is taken by the customer.

Moving the arm link 73 downward, the grooved flap 86, the guide groove 87, and the slide pin 63 cooperatively cause the swing piece 62 of the pusher 60 to swing, and this makes the free end (not shown) of the push end 65 force the stalled coin C toward the coin return exit 15. Thus, if the lower coin shoot 15 is tilted insufficiently, the coin C quickly rolls in the lower coin shoot 13 down to the coin return exit 15.

The function of the pusher 60 might be especially effective to evacuate several (e.g., four) interfering coins C from the lower coin shoot 13. In such a case, the pusher 60 would push the one farthest from the coin return exit 15 among the coins C in the lower coin shoot 13. In this way, all the coins C can be quickly forced toward the coin return exit 15, and it can be avoided that the coins stick in the midst of the lower coin shoot 13. If the required number of the coins is to increase to four, the locating member 52 of the blocker 46 should be fitted in the fourth one or the dent 44 in the guide member 31, as shown in FIG. 7.

Returning to FIGS. 9 and 10, braking the depressing force against the trigger push bar 71 of the coin return mechanism 70, the elastic force of the spring member 79 restores the trigger push bar 71 and the pivotal piece 72 to their respective initial positions, and accordingly, the arm link 73 moves upward. This also causes the guide member 31 and the pusher 60 to return to their initial positions. The coins once deposited are returned in the aforementioned manner.

Coin Evacuation

Evacuation of coins from the coin detection apparatus 1 will now be described. For explanation only, it is assumed that a single coin is required to get the item from the vending machine. When the customer turns the rotation handle 251 without depositing a coin, the bevel gear 217 rotates as mentioned before, and the rotation is transmitted to the bevel gear 124. As a result, the rotary disk 100 is rotated in the clockwise direction, as shown in FIG. 12. In this situation, no coin is deposited in the lower coin shoot 13, and hence, the piece 121 extends outward and pushes the contact piece 125 back. Then, the piece 121 does not retract but instead leans on the stopper piece 128, and hence, the rotary disk 100 coupled to the annular plate 103 can no longer rotate. Since the rotary disk 100 is prevented from rotating, the customer is not able to turn the rotation handle 251.

As can be seen in FIG. 13, since the coin C is not in the lower coin shoot 13, the contact pin 136 does not contact the coin C. Right after the rotary disk 100 begins rotating, the slide pin 131 extending from the swing piece 135 drops in the wedge-shaped notch 140, and the stopper pin 137 blocks the piece 121 from rotating. This inhibits the rotary disk 100 from rotating. Since the rotary disk 100 is not able to rotate and then the rotation handle 251 is disabled from turning, the customer should not be able to take the item A out.

When the single coin C is deposited through the coin drop 221 into the coin shoot inlet 11 as mentioned above, the coin C falls into the lower coin shoot 13. After that, as shown in FIG. 6, since the shaft 47 of the blocker 46 blocks the lower coin shoot 13, the coin C is prevented from rolling by its own weight.

In such a situation, the customer's turning the rotation handle 251 causes the bevel gear 217 to transmits its rotation to the bevel gear 124, and this makes the rotary disk 100 rotate in the clockwise direction.

Referring to FIGS. 6 and 12 for the purpose of comparison, since the contact piece 125, having its contact face 127 abutted on the coin C that is held by the blocker shaft 47, is not pushed up by the piece 121. On the contrary, the contact piece 125 makes the piece 121 retract against elasticity of the spring member 122. As a consequence, the piece 121 also retracts from abutment against the stopper piece 128, and hence, the rotary disk 100 is permitted to rotate. In this sense, the contact piece 125 serves as a means for detecting a diameter of the coin C. The rotary disk 100 includes a sawtoothed gear wheel 105 that is in press contact with the stopper nail 106, and hence, it rotates only in one way or in the clockwise direction.

Further referring to FIGS. 14 and 13 for the purpose of comparison, the coin C is deposited in the lower coin shoot 13, and once the contact pin 136 bumping on the coin C inhibits the swing piece 135 from swinging farther. While the rotary disk 100 is rotating, the contact pin 131 does not drop in the notch 140, and the stopper pin 137 does not block the piece from rotating. Therefore, the rotary disk 100 continues to rotate. On the other hand, when the coin C is thinner or the coin C is not in position (i.e., less than the predetermined number of the coins C are deposited in the lower coin shoot), the contact pin 131 drops in the notch 140 to make the stopper pin 137 block the rotation course of the piece 121, and the rotary disk 100 stops rotating. In this sense, also, the swing piece 135 serves as a means for detecting a thickness of coins.

In order to rotate the rotary disk 100, initially some force is needed to make the locating pin 109 push up the locating piece 110 and put it aside against the elastic force of the spring 112, and subsequently, the force may be reduced.

As the rotary disk 100 rotates, the step 104 of the annular plate 103 pushes the trailing edge 146 of the resist element 142 against the elastic force of the spring member 143 while the circumference of the annular plate 103 continually pushes the trailing edge 146 of the resist element 142, as can be seen in FIG. 7. Meanwhile, the leading edge 145 of the resist element 142 extends to get engaged with the stopper thrust 89 of the arm link 73, and thus, the downward movement of the arm link 73 is prevented. As mentioned below, while the floor plate 20 still tilts, the trailing edge 146 of the resist element 142 drops in a dent (the recessed portion 120) defined in the circumferential edge of the annular plate 103, and the elastic force of the spring member 143 restores the resist element 142 to its initial position.

Also, while the rotary disk 100 is rotating, one end of the recessed portion 120 in the rotary disk 100 leans on the floor plate 20 of the lower coin shoot against the elastic force of the spring member 26 to tilt the floor plate 20, and subsequently, a side edge of the rotary disk continues to tilt the floor plate 20, as shown in FIGS. 6 and 15. When the other end of the recessed portion 120 in the rotary disk 100 reaches the floor plate 20, the floor plate 20 is disengaged from the rotary disk 100. This permits the floor plate 20 to protrude into the assembly 2 because of the elastic force of the spring member 26, and thus, the lower coin shoot 13 is reset.

While the floor plate 20 tilts, the lower coin shoot 13 is under deconstruction, and the coins C on the floor plate 20 fall directly into the coin drop 17 (see FIG. 4) and further fall through the elongated hole 218 in the bank box (not shown) that keeps them. In this embodiment, in order to ensure that the coins C in the lower coin shoot 13 fall in the coin drop 17, most of the coin supporting component or the floor plate 20 is adapted to retract from the lower coin shoot 13. However, only part of the coin supporting component, namely, only part of the floor plate 20 may be adapted to retract from the lower coin shoot 13. In the latter case, the coins C can similarly be evacuated from the lower coin shoot 13 to the coin drop 17.

While the floor plate 20 tilts, the coin stop pin 29 of the swing piece 30 protrudes out of the opening into the assembly 2, as shown in FIG. 10. A coin that is not in the lower coin shoot 13 but is in the vicinity of the coin receiver 16 has its lower edge abutted on the stop pin. This is useful to prevent more than the predetermined number of the coins C from falling into the coin drop 17.

In this manner, depositing the predetermined number of the coins C and then turning the rotation handle 25 cause the rotary disk 100 to make a single turn to collect the coins C in the bank box, which makes the turn table 260 rotate so that the customer can take the item A. The rotary disk 100 rotates till the locating pin 109 bumps against the locating piece 110, and then stops rotating.

In the above discussion, addressed is a case where the single coin is required, but assuming that four of the coins are required to get the item A, the locating member 52 of the blocker 46 should be fitted in the fourth dent 44 in the guide member 31, as mentioned above. In such a case, with four of the coins C in the lower coin shoot 13, the contact piece 125 and the swing piece 135 detects the coin farthest from the coin return exit 15 among others, and hence, rotation of the rotary disk 100 is permitted.

However, with less than four of the coins C in the lower coin shoot 13, the contact piece 125 and the swing piece 135 do not detect the one that should have been in the farthest position from the coin return exit 15, and hence, rotation of the rotary disk 100 is not permitted. Additionally, with less than four coins C in the lower coin shoot 13, yet the contact face 127 of the contact piece 125 might contact one of the coins C for some reason. In this case, the rotary disk 100 does not rotate. That coin is shaky because it does not lean against another one of the coins C stopped by the shaft 47 of the blocker 46. Thus, the contact piece 125 is pushed up due to its contact with the extending piece 121, and then pushes by itself that shaky coin toward the coin return exit 15. As a result, the piece 121 does not retract beneath the annular plate 103 but instead bumps against the stopper piece 128, and hence, rotation of the rotary disk 100 is not permitted. Described so far is a manner of coin evacuation.

It is contemplated that the best mode of the coin detection apparatus according to the present invention preferably includes both a mechanism of determining a valid thickness of the coins C in the lower coin shoot 13 to rotate the rotary disk 100 and a mechanism of determining a valid diameter of the coins to rotate the rotary disk 100, and such the coin detection apparatus has been described so far. However, the coin detection apparatus simply with either one of the mechanisms effectively works to prevent the rotary disk 100 from rotating when invalid coins C are deposited in the lower coin shoot 13.

In the above-mentioned embodiment, only for convenience of explaining the best mode of the coin detection apparatus according to the present invention, the contact piece 125 is exemplified as a pusher component against the piece 121 that extends from the annular plate 103. The pusher component or the contact piece 125 may be replaced with any alternative component. For instance, the piece 121 may substitutionally be used to push the coin farthest from the con return exit 15 among others. In such a case, a position where the blocker 46 is should be varied (e.g., closer to the anterior of the apparatus) to make the piece 121 push the coin farthest from the coin return exit 15.

This specification is based upon Japanese Patent Application No. 2001-110643. The contents of the application is incorporated in this specification by reference to the application.

In an aspect of the present invention, the improved coin detection apparatus includes a coin duct leading to a coin return, a blocker that blocks the coin duct to prevent coins from rolling by their own weights toward the coin return, and a pusher that pushes an end of a sequence of coins held in the blocked coin duct toward the coin return. A coin return mechanism functions to retract the blocker to let the coins roll toward the coin return while the pusher is moved toward the coin return to push the coins thereto. Hence, the improved coin detection apparatus is advantageous in that it can avoid coins' sticking in the coin duct and that the coins once deposited can be rapidly returned.

In another aspect of the present invention, the improved coin detection apparatus includes a coin duct leading to a coin return, a guide member extending in parallel with the coin duct and capable of pivoting, and a slidable and relocatable blocker incorporated in the guide member to block the coin duct and prevent coins from rolling by their own weights toward the coin return. Hence, the improved coin detection apparatus is advantageous in that the blocker is varied in position to regulate the number of coins temporarily kept in the coin duct and that pivotal movement of the guide member simply enables the blocker to protrude into and retract from the coin duct.

In still another aspect of the present invention, the improved coin detection apparatus includes a coin duct leading to a coin return the whole of or part of which is made of a floor plate protruding into an assembly of the apparatus, and a rotary disk that, as it rotates, has its recessed edge engaged with the floor plate to make the floor plate retract so as to evacuate coins from the coin duct and fall them into a coin drop. Hence, the improved coin detection apparatus is advantageous in that the coins can be rapidly evacuated from the coin duct and that coins' sticking in the coin duct can be avoided.

In yet another aspect of the present invention, the improved coin detection apparatus includes a rotary disk having a piece that extends from it and retracts beneath it. The piece, when abutted on a coin either directly or indirectly, retracts beneath the rotary disk, and this induces rotation of the rotary disk. Hence, the improved coin detection apparatus advantageously provides an innovative mechanism.

In further another aspect of the present invention, the improved coin detection apparatus includes a rotary disk having a piece that extends from it and retracts beneath it, and a pusher that makes the piece retract while contacting an circumferential face of a coin. When the piece retracts, rotation of the rotary disk is permitted. The improved coin detection apparatus provides an innovative mechanism and is advantageous in that the pusher also serves as a means for detecting a diameter of a coin.

In still another aspect of the present invention, the improved coin detection apparatus includes a swing member having a contact pin and a stopper pin. Without coins in the coin duct, the contact pin contacts nothing in the coin duct while the stopper pin gets engaged with recessed edge of the rotary disk to prevent it from rotating. With coins in the duct, the contact pin abuts on the coin, and the stopper pin is not engaged with the side edge of the rotary disk, which permits the rotary disk to rotate. The improved coin detection apparatus provides an innovative mechanism and is advantageous in that the swing member serves as a means for detecting a thickness of coins.

In another aspect of the present invention, the improved vending machine includes a guide member. After set in the guide member, the coin detection apparatus according to the present invention is simply moved forward to have its engagement element fitted in a mating element of the guide member. The engagement element is securely engaged with nails of the mating element. Thus, the present invention provides an innovative mechanism and is advantageous in that installation of the coin detection apparatus in the vending machine can be facilitated and that the coin detection apparatus is automatically fixed in position.

In still another aspect of the present invention, a box-shaped cabinet of the improved vending machine has its one side provided with a hook capable of extending from and retracting within the cabinet and the other side provided with an engagement element mated with the hook. Hence, more than one of the improved vending machine modules can be connected side by side, and they can be settled stably.

What is claimed is:

1. A coin detection apparatus determining if valid coins are deposited, comprising
a coin duct receiving coins deposited,
a support member forming a part of the coin duct to bear the coins thereon, and
a release means for pivoting the support member in a direction orthogonal to major surfaces of the coins standing upright on the support member to evacuate the coins from the coin duct.

2. A coin detection apparatus according to claim 1, wherein the release means includes a blocking member that blocks other coins from entering the coin duct during evacuating the coin duct.

3. A coin detection apparatus determining if valid coins are deposited, comprising
a coin duct receiving coins deposited,
a rotary member rotating to induce coins in the coin duct to drop into a coin collector,
a stopper mechanism determining if a thickness of the coins in the coin duct is valid and depending upon the result, getting engaged with the rotary member to block the rotary member from rotating.

4. A coin detection apparatus according to claim 3, wherein the resist mechanism includes
a pivotal member urged toward the coins in the coin duct,
a detection element provided in the swing member and protruding into and retracting from the coin duct, and
a stopper member provided in the swing member and getting engaged with the rotary member to block the rotary member from rotating.

5. A coin detection apparatus determining if valid coins are deposited, comprising
a coin duct receiving coins deposited, the coin duct including an outlet that leads to other parts of coin passage, and
a means for urging the coins in the coin duct toward the outlet.

6. A coin detection apparatus according to claim 5, further comprising a blocker member blocking the coin duct to hold the coins back,
the blocker member being cooperative with the means for urging the coins toward the outlet to release the coins roll from holdback.

7. A coin detection apparatus according to claim 6, wherein the blocker member is fixed in varied positions, depending upon the number of the coins required to deposit, and it is adapted to slide along the coin duct.

8. A coin detection apparatus determining if valid coins are deposited, comprising
a coin duct receiving coins deposited,
a rotary member rotating to evacuating coins from the coin duct,
a member movable in almost radial directions relative to the rotary member and extending from and retracting beneath the rotary member, and
a stopper member getting engaged with the movable member to block the rotary member from rotating,
without the coin in a predetermined position within the coin duct, the movable member extending to disable the rotary member from rotating, and
with the coin in the predetermined position within the coin duct, the movable member avoiding interference with the stopper member to enable the rotary member to rotate.

9. A manual vending machine comprising
a box-shaped cabinet at least including a coin collector for coins deposited, and
a coin detection unit including
(a) a coin duct receiving coins deposited,
(b) a rotary member rotating to induce coins in the coin duct to drop into the coin collector, and
(c) a stopper mechanism determining if a thickness of the coins in the coin duct is valid and depending upon the result, getting engaged with the rotary member to block the rotary member from rotating
the coin detection unit being detachably applied to the cabinet.

10. A manual vending machine according to claim 9, wherein the coin detection unit and the cabinet respectively have engagement elements mated with each other.

11. A manual vending machine according to claim 10, wherein the coin detection unit includes an engagement member while the cabinet includes a mating member fitted on the engagement member.

12. A manual vending machine according to any of claim 9 to claim 11, wherein the cabinet includes a means for fixing itself to a cabinet(s) of other manual vending machine(s).

13. A coin duct that receives a plurality of coins deposited by a user, comprising
a support member forming a part of the coin duct to bear the coins thereon, and
a release means for evacuating the coins from the coin duct, the release means responding to a manipulation of the user to release the support member from its effective position to an idle position and release substantially simultaneously all the coins from the support member.

14. A coin duct according to claim 13, wherein the support means is moved to the idle position in a direction orthogonal to major surfaces of the coins standing upright on the support member.

15. A coin duct according to any of claim 13 and claim 14, wherein the release means evacuates the coins and let them go as gravitational force pulls them.
